(19) United States
(12) Patent Application Publication
(10) Pub. No.: US 2018/0117827 A1
(43) Pub. Date: May 3, 2018

(54) A METHOD TO PRODUCE PLASTIC TUBE THAT HAS AT LEAST ONE STIFFENER

(71) Applicant: PLASTIC PIPE MOBILE OU, Pärnu (EE)

(72) Inventor: Seppo TAKALA, Pärnu (EE)

(73) Assignee: PLASTIC PIPE MOBILE OU, Pärnu (EE)

(21) Appl. No.: 15/568,048

(22) PCT Filed: Apr. 15, 2016
(86) PCT No.: PCT/FI2016/000009

§ 371 Date: Oct. 20, 2017

(30) Foreign Application Priority Data
Apr. 22, 2015 (FI) 20150128

(51) Int. Cl. B29C 53/56; B29C 47/02; B29C 53/58; B29C 53/62; B29C 63/10; B32B 1/08; B32B 3/14; B32B 3/18; B32B 3/28; B32B 7/04; B32B 27/08; B29C 47/00; F16L 11/16; F16L 9/16

(52) U.S. Cl. CPC B29C 53/566; B32B 2597/00; B29C 53/581; B29C 53/587; B29C 53/62; B29C 63/105; B32B 1/08; B32B 3/14; B32B 3/18; B32B 3/28; B32B 7/045; B32B 27/08; B29C 47/0064; F16L 11/16; F16L 9/16; B29C 47/021

(57) ABSTRACT

A plastic tube has an inner tube, a stiffener layer, and an outer tube. The inner tube is arranged the support organ. A corrugated stiffener preform is formed with corner area walls shaped thinner than the other walls. The preform is fed upon the inner tube to form a stiffener layer that advances with a certain pitch upon the inner tube. The corner parts of every stiffener yield and the brush angle (β) between the lamellas of the outside gets greater than the corresponding brush angle between the lamellas of the inner side. The stiffener is joined to the inner tube with a melted plastic layer and fed upon the stiffener plastic tape joined to the stiffener with a melted plastic layer. Between the settled edges of the plastic tape a spiral weld joint is formed so that the plastic tape forms the outer tube.

The aspects of the disclosed embodiments are directed to a method to produce plastic tube with at least one stiffener, which plastic tube consists of at least an inner tube, stiffener and an outer tube.

The usages of the disclosed embodiments are light weight large diameter plastic tubes that have at least two walls and between them at least one spiral line shape stiffener. The mentioned tubes are used in sewer systems, bridge sewer ducts, containers, and in tube preforms to be machined later.

The before mentioned tubes are produced using the known technology so that first the inner tube is produced by for instance the spiral joint technique either upon a race or a rotating core of the starting tube by feeding plastic tape upon the mentioned race or the rotating support organ and by welding together in the spiral joint the meeting edges of the plastic tape and after this, a smooth surface or corrugated shape stiffener is installed following the shape of the spiral joint upon the inner tube and it is welded there fixed. In the next phase of the work, the outer tube is installed upon the stiffener with the same technique as the inner tube was installed upon the support organ and the outer tube is welded fixed to the stiffener, and at the same time the plastic tape edges that meet in the spiral joint of the outer tube are welded together. If the tube contains more cylinder layers and stiffener layers between them, it is continued in the same way until the desired construction has been achieved.

In the international patent publication WO 2012090185, a production method of the plastic tube with a stiffener strengthened tube using known technology has been presented. In this method, corrugated stiffener is fed upon a plastic tape composed inner tube and in the next phase the plastic tape forming the outer tube upon the mentioned stiffener. The stiffener that comes upon the inner tube has the same pitch as the plastic tape forming the inner tube and the stiffener has been adjusted to the joint of the inner tube. When the meeting edges of the tape forming the inner tube have been welded together with melted plastic material just before feeding the stiffener, the inner edge of the stiffener at the point of this joint sinks into this melted material and, additionally, the layer of the melted material upon the inner tube at the point of the stiffener welds the inner tube and the stiffener together. At the same time as the corrugated stiffener is fed upon the inner tube, the outside edge of this stiffener is stretched in order to make its peripheral length correspond the peripheral length of the inner surface of the outer tube. The welding of the outer edge of the stiffener to the outer tube and meeting edges of the plastic tape forming the outer tube are made at the same time.

One method of the known technology to produce large light weight construction plastic tubes is to make first U or L shaped tape from pre-fabricated tapes that then is fed upon a core and is then like a rotating screw, and then a spiral-weld tube is achieved with the pitch of the width of the tape that contains an essentially smooth surface buttress. The rounds beside the frame part are joined together and a new layer is formed upon the stiffener buttresses also by feeding tape in the shape of a spiral line.

This last described technology has been presented for instance in PCT applications no: PCT/IB2011/056029 and PCT/IB2011/056030.

One solution of the known technology is to fit the corrugated stiffeners upon the inner tube of the plastic tube essentially lengthwise of the mentioned tube. In this case, the stiffeners are produced during extruding the tube. This known technique is presented in the patent publication U.S. Pat. No. 7,550,102 B2 and the advantage of this construction is that it can be used in installations under water. The space between the inner and the outer tube can be filled for instance with concrete to balance the tube much easier that the corresponding state of the spiral stiffener tube.

The greatest draw-back of the firstly mentioned known technology is that keeping the stiffener that winds around the inner tube in the right position (upright) is very difficult, because when stretching the outer edge of the stiffener it gets thinner towards the outer edge. Therefore, it is necessary to arrange support for the stiffener and the tape to be welded to it forming the outer tube so that they would be in right position at the moment of welding. Without this kind of difficult to make support arrangement it is not possible to get suitable pressure to the welding point to achieve a sufficiently good quality weld. The pressure pressing the parts together must be within certain limits during welding and some time afterwards. This pressure is typically for polyolefin's about 100-200 kPa. Without the mentioned suitable pressure pressing together the parts to be welded it is difficult to get a weld that meets the quality criteria and when this pressure is set in using the known technique a danger of buckling sensitivity and malformations of the outer tube occur and this can lead to a collapse of the tube.

A drawback of this technique has also shown to be the limited flexibility of the corrugated stiffener, because it is always necessary to set a minimum value for the thickness of the stiffener material for the reasons of the durability and then the flexibility of the corner points of the corrugations is dependent on this thickness of the material.

Because of the structures (for instance overlapping when using U or L profiles) it is necessary to use more material than what the strength capabilities themselves demand.

The greatest drawback of the last presented known technique (U.S. Pat. No. 7,550,102 B2) is very high production costs. The tools that are used are very expensive, especially when producing large tubes and it is necessary to make own tools for every tube size.

The intention of the present disclosure is to achieve such a method to produce plastic tubes with at least one stiffener that avoids drawbacks of the known technology. It is characteristic for the solution of the invention what has been presented in the characterizing parts of the claims 1-3.

The greatest advantages of the disclosed embodiments come to that, that the installation and the welding of the stiffener or stiffeners and the outer layer get considerably easier and the high quality of the produced products can be assured without additional arrangements causing additional costs. Therefore, the production speed can safely be raised and then considerable economical advantage can be achieved.

The disclosed embodiments are described closer in the enclosed drawings, where

FIG. 1, presents in 3D a setting according to the disclosed embodiments,

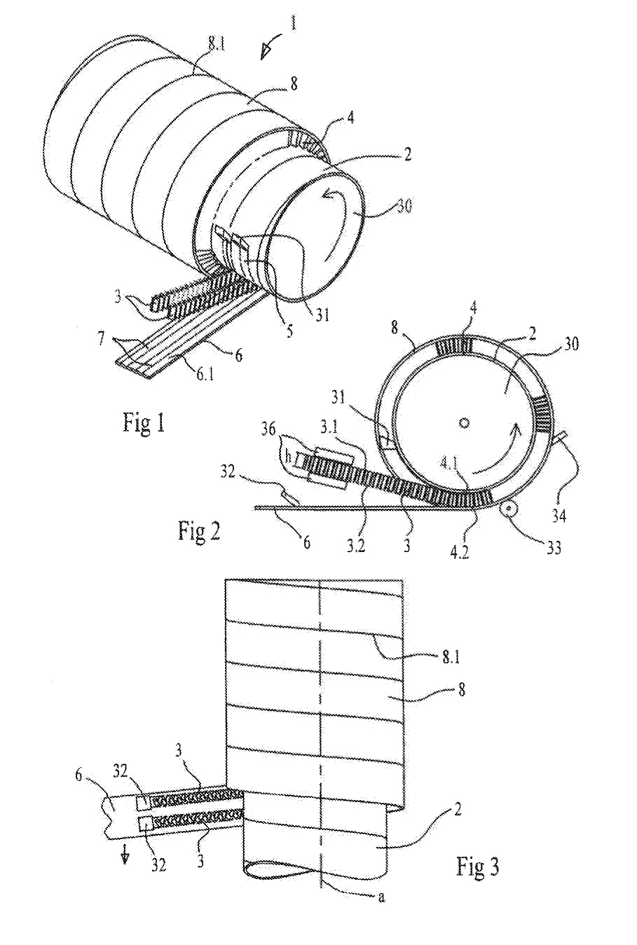

FIGS. 2 and 3 present the before mentioned setting directly from side and above,

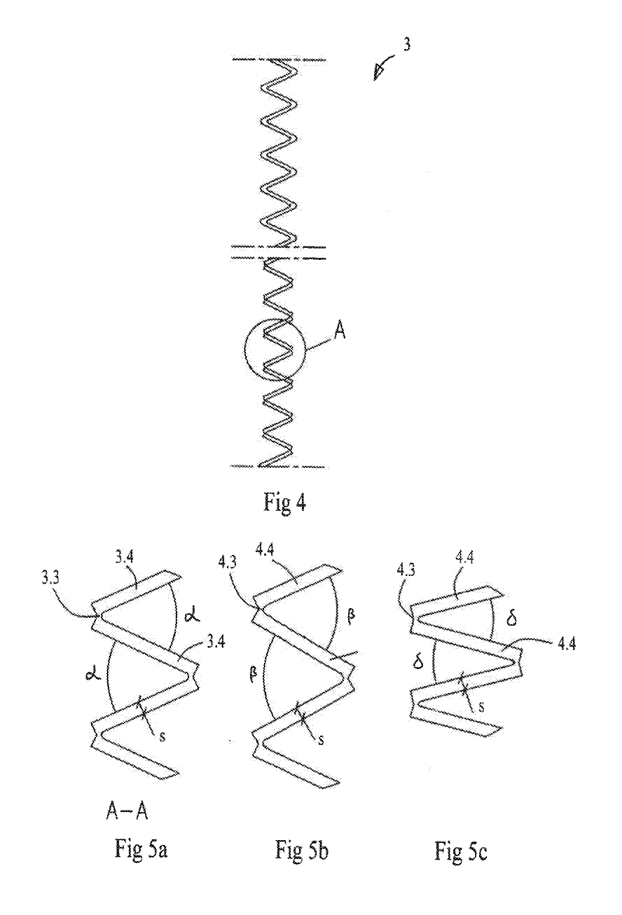

FIG. 4, presents the stiffener preform of the method of the invention seen from above,

FIG. 5a, presents the enlarged detail “A” of the before mentioned preform, 5b presents the stiffener stretched from the outer side, and 5c presents a stiffener compressed from the inner side,

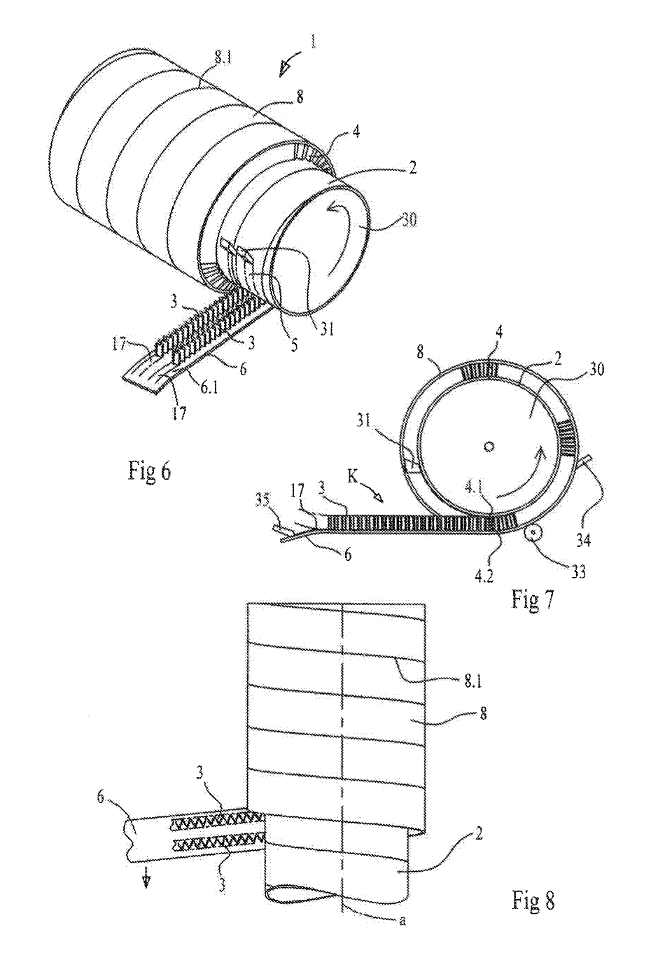

FIG. 6, presents in 3D another setting belonging to the method according to the disclosed embodiments,

FIGS. 7 and 8, present the before mentioned setting directly from side and above.

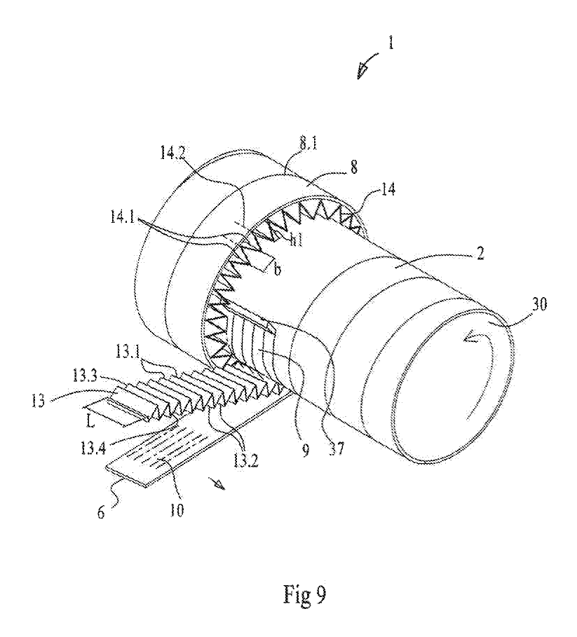

FIG. 9, presents a third usage setting of the method according to the disclosed embodiments.

Now follows an explanation of the usage of the method of the disclosed embodiments as an example referring to the mentioned figures.

In FIGS. 1-3, it has been described a setting to produce a large plastic tube with the method of the invention. The inner tube 2 rotating around its axis in the process has been made upon a support part 30 that is a closed surface core in this example and upon the inner tube (around) are fed two corrugated shape stiffener preforms 3 in such a way that they form two spiral stiffeners 4 side by side and certain distance from each other. In this example, one of these stiffeners is directed upon the spiral welding joint of the inner tube to support it and the other to the side of the welding joint and it is extruded thin, essentially stiffener wide melted plastic layers 5 from the welding heads 31 upon the inner tube 2 in the line the stiffeners come, and the stiffener preforms 3, the inner sides 3.1 of which 3.1 have been pre-heated, sink into this layer, get welded fixed to the inner tube 2 and form the stiffeners 4. In this example, one of these stiffeners is directed upon the spiral weld joint of the inner tube to strengthen it and the other beside the weld joint and it is extruded from the weld head 31 nozzles upon the inner tube 2 in the input line of the stiffeners thin essentially stiffener wide layers 5 of the melted plastic and the stiffener preforms 3 the inner sides 3.1 of which have been pre heated sink into this, get welded fixed to the inner tube 2 and form stiffeners 4. Upon the stiffeners 4 (around) it is fed plastic tape 6 with the same pitch as the starting tube has been produced and also the stiffeners are fed. Upon the plastic tape 6 in the same lines with the feeding lines it is extruded from the weld head 32 nozzles thin melted spastic layers 7 and when this pre heated plastic tape bends fixed to also pre heated outer sides 4.2 of the stiffeners, they get welded fixed to them. The feeding machinery of the stiffener and the plastic tape and the weld heads are thus in movement in relation to the support part 30 and the inner tube 2 so that this movement is in the direction of the support part middle axis a. In the setting there is a weight organ 33 that in this case is a reel and its task is to press the stiffeners 4 and the plastic tape 6 that is forming the outer tube 8 against each other with a suitable pressure and also the stiffeners against the inner tube. In the next stage, in the spiral joint of the outer tube contrarily placed sides are welded together with melted plastic material that is extruded to the welding point from the side of the outside surface from the weld head 34 nozzles.

In order to be able to focus to the setting through the weight organ 33 or by tightening the plastic tape sufficient pressure to obtain faultless weld joints between the parts and at the same time to avoid the unfavourable malformations of the stiffeners 4 and the outer tube 8 and this way obtain the desired values set for the ring stiffness of the plastic tube 1; this present disclosure offers two different ways to realize it.

When instead of one stiffener 4 at least two parallel stiffeners are used following the pitch of the outer tube spiral joint, due to tighter stiffener construction the stiffeners and the outer tube maintain their favourable shapes and the welds of high quality can be made. In this case, the stiffeners can also be lower and the need to stretch their outer sides 4.2 is smaller and their tensile properties get better than in one stiffener known technology constructions.

Another way to achieve the mentioned good end result with the disclosed embodiments is to form such a one stiffener construction where the stiffener 4 is able to resist the buckling and other unfavourable twisting and thus to prevent unfavourable malformations to occur in the outer tube 8. It is known that it is necessary to stretch the stiffener outer side 4.2 when the welding is from the inner side 4.1 to the inner tube 2 to suite the inner race and thus the width of the outer side of the stiffener gets narrower than the inside width w of the stiffener preform 3 and the tensile properties of the stiffener get worse. It is also known that fitting the corrugated stiffener to correspond the outer tube 8 inner surface ring length with its outer circle length is often too challenging because it requires bending the corrugation construction from its corner parts and this causes problems for instance through unfavourable shape changes. In the method according to the invention, this problem is avoided by forming the corner parts 3.3 of the inside 3.1 and the outer side 3.2 of the stiffener preform thinner than the wall thickness s of its lamellas. In FIG. 4 there has been described a stiffener preform 3 according to the invention, in FIG. 5a there has been presented its structure in more detail and in FIG. 5b there has been presented the corresponding situation with the ready stretched out circle of the stiffener 4. When the outer side 4.2 of the stiffener is stretched the thin construction of its corner parts 4.3 yields and the stiffener maintains its stabile shape also in the outer side 4.2. In this example, the corner part thinned walls are about ¼ of the ordinary lamella 3.4 wall thickness s of the stiffener preform.

Another way to produce the plastic tube 1 according to the disclosed embodiments has been presented in FIGS. 6-8. In this application, the stiffener preform or preforms are first welded to the plastic tape 6 that forms the outer tube 8 by extruding from the weld head 35 nozzles thin melted plastic layers 17 upon the plastic tape and by pressing the plastic tape and the stiffener preform(s) together. Thereafter, the combination K of these mentioned parts is fed upon the inner tube 2 (around) and then the inside 4.1 of the stiffener 4 gets compressed so much that its circle length corresponds inner tube 2 outer surface circle length. In FIG. 5c there has been presented this kind of readymade stiffener where the dominant brush angle δ in the inside 4.1 between the lamellas is smaller than the corresponding brush angle α of the stiffener preform. From the weld head 31 nozzles will a thin melted plastic layers 5 be extruded upon the inner tube to the points of the stiffeners, the inner tube, the stiffeners, and the outer tube are pressed together using the weight organ 33. In the next phase, the against each other set sides are welded together with melted plastic material that is extruded to the welding point via outside from the weld head 34 nozzle.

When using more than one stiffener and being then able to reduce the height h of the stiffener and the need to expand the brush angle β between the stiffener lamellas 4.4 gets also smaller and then the lamellas 4.4 of the stiffener follow more precisely the round shape of the inner and the outer tube. The present disclosure gets realized when using any amount of the stiffener.

One solution according to the disclosed embodiments to produce a plastic tube with a stiffener is presented in FIG. 9. In this method, a stiffening layer 14 made of the stiffener preform 13 is welded using melted plastic material upon the inner tube and upon these stiffeners is formed the outer tube 8 in the before told way. The stiffener preform 13 is fed upon the inner tube 2 so that its every other corner point 13.1 comes upon the inner tube from weld head 37 extruded melted plastic layer 9 the distance of the pitch corresponding the length L of this stiffener preform. This way, the sides 13.3, 13.4 of the stiffener preform 13 get placed upon the inner tube 2 meeting each other and a stiffening layer 14 is formed the corners 14.1 and 14.2 of which are essentially lengthwise the tube. The diversion from the lengthwise direction is caused by the feeding angle corresponding the pitch of the stiffener preform 13. The stiffening layer 14 gets welded in its corners to the inner tube and there-after, the outer layer 8 is formed upon the stiffening layer 14, the way that has been presented earlier. The corners 14.2 are joined upon the plastic tape 6 extruded melted plastic layer 10 to the outer tube 8. The height h1 of the stiffening layer 14 is kept constant by adjusting the corners 13.1 of the stiffener preform 13 with a constant distance b upon the inner tube. The outer tube 8 shape is a polygon the deviation of which from the corresponding round shape can be kept within acceptable tolerances by fitting a sufficient amount of corners 13.2 for each round.

So it is possible to use the method according to the disclosed embodiments for instance by applying to the plastic tube to be produced one or more spiral stiffeners 4 (FIGS. 1-3 and 6-8). When using one stiffener the stiffener preform 3 can be made so wide that also the outside 4.2 of the stiffener to be made gets sufficiently wide.

In the different applications of the disclosed embodiments the sufficient tensile properties of the stiffener(s) 4 can be assured for instance by keeping the brush angle β between the lamellas 4.4 of the outside 4.2 of the stiffener 4 sufficiently small, so that too much stretching of the stiffener does not weaken the construction too much. It can be said that it is favourable to form the brush angle 13 smaller than 120°. The brush angle α between the lamellas 3.4 of the stiffener preform 3 depends, naturally, on the height h and the width w of the stiffener and also the outside diameter of the inner tube.

The stiffener can always be dimensioned by the size of the tube 1 and by the demanded properties, like the ring stiffness.

When installing the stiffener 4 or the stiffener layer 14 its sides to be welded can be preheated up to a suitable temperature that the situation requires and it is favourable that this temperature is such that a sufficiently thick melted material layer is formed on the surface of the part to be welded so that its temperature corresponds the temperature of the extruded tape. It is also possible to arrange support for the stiffener in the phase where it is fed upon the inner tube 2 or the plastic tape 6.

The production of the stiffener preform can be made beforehand using suitable as such known equipments either before producing the tube 1 or during this production process. The forming of the walls of the corner parts 3.3 of the stiffener preform thinner than the lamellas 3.4 can be made in the connection of making the mentioned corrugate structure by cutting away a part of the thickness of the walls of the corner parts. It can be said as an example that ½-¾ is cut off from the thickness of the corner parts. Also any other cutting depth or forming method realizes the present disclosure.

The preheating of the plastic tape 6 of the stiffener preform 3 of the inner tube 2 can be performed using any known technique method. It is essential for the disclosed embodiments that the welding temperatures are case by case in a favourable level. In FIG. 2, the support instruments 36 of the stiffener preform are presented, in connection of which there also have been joined heating equipments.

When using more than one stiffener 4 the plastic tapes 6 to be used can be wider than now to form the outer tube 8 and thus the production speed can be raised due to the greater pitch per round. It is known that with today's methods it is possible to reach 10 m/minute welding speeds and with the help of the disclosed embodiments this speed can be exceeded considerably.

The weight organ can be a reel or a dragging organ depending on the case. The weight organ can also consist of a number of reels or other organs in touch with the outer tube.

When using one wide corrugate it is always dimensioned so that no unfavourable malformations, like buckling, yielding, or blisters, occur in the parts of the tube 1.

As support organ 30, for instance a race or core or their combination can be used so that in the beginning end a rolling core is used and thereafter a race. In connection of the support organ, a gliding stopper can be used to guide the stiffener preform and the plastic tape.

The stiffener(s) can also be placed so, that none of them comes to the point of the spiral joint of the inner tube, or so that some of them come at least partly to the point of the spiral joint of the outer tube.

The inner tube 2 can be formed at the same time with the production of the tube 1 or in a separate process. So the inner tube is formed or is arranged upon the support equipment when producing the tube 1.

It is worth noticing that even though this description sticks to only one type of for the disclosed embodiments favourable realization example this does not want to limit the usage of the disclosed embodiments for only this type of example but many variations are possible in the scope of the inventive idea that is defined in the claims.

1. A method to produce plastic tube with at least one stiffener which mentioned plastic tube (1) consists at least of an inner tube, a stiffener layer and outer tube and according to which method the plastic tube (1) is produced as follows:
a. a solid inner tube (2) is composed or arranged upon the support organ (30),
b. at least one stiffener preform (3) is fed tangentially and with a pitch upon the inner tube (2) and thus a with a certain pitch advancing stiffener layer is formed upon the inner tube,
c. the stiffener (4) is fixed to the inner tube (2) by extruding upon the inner tube a melted plastic layer settling between these mentioned parts,
d. there is fed upon the stiffener (4) with a certain pitch plastic tape (6), upon the stiffener side (6.1) of which, to the point where it joins to the stiffener, there is fed a melted plastic layer (7), and the plastic tape forms the solid outer tube (8) of the plastic tube,
e. the plastic tape (6) is tightened or pressed so that between the inner tube (2) and the stiffener (4) and between the stiffener and the plastic tape (6) there is formed a pressure load,’
f. between the against each other placed edges of the tape (6) that form the outer tube (8) there is formed a spiral weld joint (8.1) by extruding melted plastic material to the mentioned point
wherein
g. the stiffener preform (3) that is corrugated is formed so that its corner part (3.3) walls are made thinner than the other walls, like lamellas, of the preform,
h. when feeding the stiffener preform (3) upon the inner tube, the corner parts (4.3) of the forming stiffener yield while the brush angle ((3) between the lamellas (4.4) of the outer side (4.2) of the stiffener comes bigger than the corresponding brush angle (□) of the lamellas (3.4) of the inner side (3.1) of the stiffener preform,

2. A method to produce a plastic tube with at least one stiffener, which mentioned plastic tube (1) consists at least of inner tube (2), a stiffener layer and an outer tube which plastic tube (1) is produced as follows:
a. a solid inner tube (2) is composed or arranged upon a support organ (30) (around),
b. the stiffener preform(s) (3) is joined to the tape (6) that forms the outer tube on the side (6.1) of the stiffener preform, to every joining point of the stiffener preform there has been extruded a melted plastic layer (17) and the mentioned parts are pressed together so that there is formed a pressure load between them,
c. the combination (K) of the stiffener preform and the plastic tape is fed upon the inner tube (2) so that they form upon the inner tube with a certain pitch advancing stiffener layer and the outer tube (8),
d. the plastic tape (6) is tightened or pressed so that between the inner tube (2) and the stiffener there is formed a pressure load,
e. between the against each other settled sides of the tape (6) that form the outer tube (18) there will be made a spiral weld joint (8.1) by extruding to the mentioned place melted plastic material,
wherein the stiffener preform (3) that is corrugated is formed so that the walls of its corner places (3.3) are thinner than the other walls of the preforms like for instance the lamellas (3.4) when the corner places (4.3) of the stiffener (4) yield so that the brush angle (δ) between the lamellas (4.4) of the inside (4.1) of the stiffener gets smaller than the corresponding brush angle (□) between the lamellas (3.4) of the stiffener preform.

3. A method to produce plastic tube that is strengthened with a stiffener which mentioned plastic tube (1) consists of at least inner tube, stiffener layer, and outer tube and which plastic tube (1) is produced as follows:
a. a solid inner tube (2) is composed or arranged upon a support organ (30),
b. corrugated stiffener preform (13) is fed upon the inner tube (2) so that it forms upon the inner tube a stiffener (14) that advances with a certain pitch, the every second corner (14.1) of which is welded with a melted plastic material layer (9) to the inner tube (2),
c. plastic tape (6) is fed upon the stiffener (14) with certain pitch, on the side (6.1) of the stiffener of which, in the place where it joins to the stiffener there has been extruded a melted plastic layer (10) so that the plastic tape forms the solid outer tube (8) of the plastic tube,
d. the plastic tape (6) is tightened or pressed so that there is formed a pressure load between the inner tube (2) and the stiffener (14) and the stiffener and the plastic tape (6),
e. between the against each other settled edges of the plastic tape (6) that form the outer tube (8) there is formed a spiral weld joint (8.1) by extruding melted plastic material to the mentioned place,
wherein the stiffener preform (3) is formed so that the walls of the corner places (3.3) are thinner than the other walls, like lamellas (3.4)

4. The method according to the claim 1 wherein there is arranged at least two stiffeners (4) to the plastic tube (1).

5. The method according to claim 1 wherein the brush angle (β) of the outside (4.2) of the stiffener is made less than 120°.

6. The method according to the claim 1 wherein the inner tube (2) and the stiffener(s) (4) and plastic tape or the combination (K) are pressed together using a pressure organ (33).

7. The method according to the claim 6 wherein that as the pressure organ (33) at least one reel is used.

8. The method according to claim 1 wherein that as the support equipment (30) a core or a race is used.
